(19) United States
(12) Patent Application Publication
(10) Pub. No.: US 2020/0126030 A1
(43) Pub. Date: Apr. 23, 2020

(54) METHOD TO DETECT MISPLACEMENT OF PACKAGES IN WRONG TRAILERS USING TRAILER MONITORING UNIT

(71) Applicant: Zebra Technologies Corporation, Lincolnshire, IL (US)

(72) Inventors: Harshavardhan Magal, Bangalore (IN); Sajan Wilfred, Kollam (IN)

(21) Appl. No.: 16/168,573

(22) Filed: Oct. 23, 2018

(51) Int. Cl. G06Q 10/08; B62D 63/08

(52) U.S. Cl. CPC G06Q 10/0833; G06Q 10/0875; B62D 63/08

(57) ABSTRACT

A system and method for of tracking proper placement of a package into a trailer at a loading dock having a plurality loading bays uses trailer monitoring units transmitting beacons detected by wearable scanners capable of determining, in conjunction with a centralized server, whether scanned packages are being loaded onto or unloaded from the proper trailer.

### BACKGROUND OF THE INVENTION

In the logistics industry any misrouting/misplacement of a package can incur huge costs to a company and can delay delivery to customers.

A typical warehouse or a sortation hub has human loaders wearing wearable computers with a barcode scanner attached. All packages have barcode labels affixed on them. Typically, software systems manage operations, and those software systems assign a dock door to each package, where the dock doors correspond to different vehicle trailers that will be used to ship the packages to destinations. That software system manages the routing of the packages to the loading area where the dock door is located. These packages can be routed to the loading area through automated vehicles or through manually-operated vehicles, such as forklifts. The human loaders at the loading area, receive the package, and scan the package using their wearable scanners. The loaders then load the package onto the vehicle trailer docked at the designated dock door.

While a package should not be provided to an incorrect dock door, and while the wrong package should not be scanned and loaded onto a vehicle trailer, errors do occur. Sometimes packages are picked up by the wrong human loader, incorrectly scanned or go un-scanned, and as a result some packages are loaded on to the wrong vehicle trailer. Such situations can greatly hinder operational efficiency. Incorrectly loaded package take up trailer capacity that can be used for other packages. Plus, for each incorrectly loaded package it is likely that a customer will not receive their requested package or delivery of that package will be delayed.

Accordingly, there is a need for a trailer monitoring unit that detects and prevents misplacement of packages or other items in incorrect vehicle trailers.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a loading facility, in accordance with an embodiment of the present invention.

FIG. 2 illustrates an interior of the loading facility of FIG. 1.

FIG. 3 illustrates a trailer monitoring unit (TMU), in accordance with an embodiment of the present invention.

FIG. 4 illustrates an exemplary block diagram schematic of system implemented in the facility of FIG. 1 to detect misplacement of packages in wrong trailer, in accordance with an embodiment of the present invention.

FIG. 5 illustrates a flowchart representative of a method of detecting misplacement of packages in the wrong trailer as may be implemented by the system of FIG. 4, in accordance with an embodiment of the present invention.

FIG. 6 illustrates a flowchart representative of an example implementation of the method of FIG. 5 as may be implemented by a wearable device in a loading facility, in accordance with an embodiment of the present invention.

FIG. 7 illustrates an exemplary schematic of an interior of a loading facility and having a configuration as may be implemented to detect misplacement of packages in the wrong trailer, in accordance with an embodiment of the present invention.

FIG. 8 illustrates a flowchart representative of an example implementation of a method of detecting misplacement of packages as may be implemented by the configuration of FIG. 7, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As used herein, the term “container” shall refer to any container transportable by at least one of a vehicle, a train, a marine vessel, and airplane, and configured to store transportable goods such as boxed and/or unboxed items and/or other types of freight. Accordingly, an example of a container includes an enclosed container fixedly attached to a platform with wheels and a hitch for towing by a powered vehicle. An example of a container also includes an enclosed container removably attached to a platform with wheels and a hitch for towing by a powered vehicle. An example of a container also includes an enclosure that is fixedly attached to a frame of a powered vehicle, such as the case may be with a delivery truck, box truck, etc. As such, while the exemplary embodiment(s) described below may appear to reference one kind of a container, the scope of the invention shall extend to other kinds of container, as defined above. Furthermore, the term “trailer” is an example of application of a container, in particular, a container used with a vehicle, such as a powered vehicle, like a delivery truck, box truck, etc.

In an embodiment, the present invention is a method of tracking proper placement of a package into a trailer at a loading dock having a plurality loading bays facing a loading dock facility. Each loading bay has a respective trailer monitoring unit. The method includes scanning, via a wearable scanner associated with a loader at the load docking, an indicia identifying the package; and the wearable scanner transmitting the scanned indicia to a server via a network communication link. The server determines, from the indicia, an assigned loading bay for the package from among the plurality of loading bays and determines an assigned trailer monitoring unit corresponding to the assigned loading bay. The server further determines a beacon identifier identifying a loading bay beacon of the assigned trailer monitoring unit, and the server communicates that beacon identifier to the wearable scanner via the network communication link. As such, when the wearable scanner detects a beacon, the wearable scanner can determine if the detected beacon is the loading bay beacon emitted by the assigned trailer monitoring unit. If the detected beacon is the loading bay beacon, then in response to the loader moving the package relative to the assigned loading bay and/or relative to the trailer, the wearable scanner determines when the package satisfies at least one of (1) a first condition indicating proper placement of the package in the trailer and (2) a second condition indicating improper placement of the package.

In another embodiment, the present invention is a method of tracking proper placement of a package into a trailer at a loading dock having a plurality loading bays facing a loading dock facility, where each loading bay has a respective trailer monitoring unit. The method includes scanning, via a wearable scanner associated with a loader at the load docking, an indicia identifying the package; and the wearable scanner transmitting the scanned indicia to a server via a network communication link. The server determines, from the indicia, an assigned loading bay for the package from among the plurality of loading bays and determines an assigned trailer monitoring unit corresponding to the assigned loading bay. The server further determines, from the indicia, a loading bay beacon, a loading bay beacon identifier, and a loading bay beacon instruction. The server communicates the loading bay beacon instruction to the assigned trailer monitoring unit, and the server communicates the loading bay beacon identifier to the wearable scanner via the network communication link. The assigned trailer monitoring unit emits the loading bay beacon in accordance with the loading bay beacon instruction. And, the wearable scanner detects the loading bay beacon and, in response to the loader moving the package relative to the assigned loading bay and/or relative to the trailer, determines, at the wearable scanner, when the package satisfies at least one of (1) a first condition indicating proper placement of the package in the trailer and (2) a second condition indicating improper placement of the package.

In another embodiment, the present invention is a method tracking proper placement of a package into a trailer at a loading dock having a plurality loading bays facing a loading dock facility, where each loading bay has a respective trailer monitoring unit. The method includes scanning the package for package data and identifying the package from the scanned package data; and determining an assigned loading bay for the package based on the scanned package data. The method further includes identifying to a mobile computer of a package loader, an assigned beacon of the assigned loading bay; and receiving, at the mobile computer, a beacon and authenticating the received beacon as the assigned beacon. The method further includes, if the received beacon is the assigned beacon, then monitoring a location of the package at the loading dock and determining when the package has satisfied at least one of a proper placement condition into a trailer at the loading dock location and determining when the package has satisfied an improper placement condition; and in response to determining improper placement, communicating the determination of the improper placement to the mobile computer.

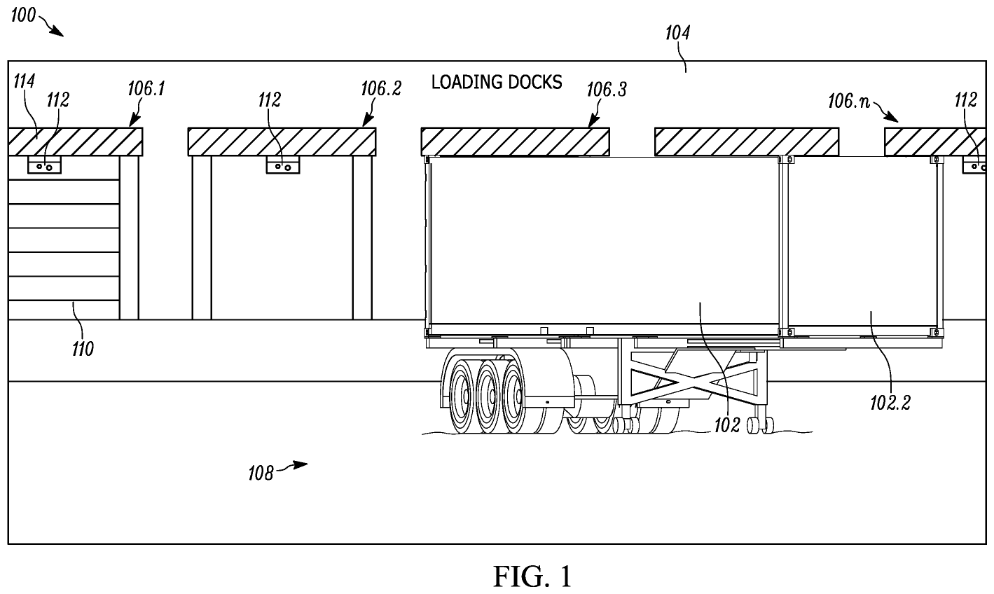

Referring now to the drawings, FIG. 1 illustrates an exemplary environment where embodiments of the present invention may be implemented. In the present example, the environment is provided in a form of a loading dock 100 (also referred to as a loading dock facility) where containers 102 are loaded with various goods and/or where various goods are unloaded from the containers 102. The loading dock 100 is comprised of a facility 104 having a plurality of loading bays 106.1-106.n facing a loading facility lot 108 where vehicles, such as semis (not shown), deliver and pick up containers 102. To be loaded, each container 102 is backed toward the facility 104 such that it is generally perpendicular with the wall having the loading bays 106, and in line with one of the loading bays (in this case 106.3). As illustrated, each loading bay 106 includes a bay door 110 that can be lowered to close the respective loading bay 106 or raised to open the respective loading bay allowing the interior of the facility 104 to be accessible therethrough. Additionally, each loading bay 106 is provided with a trailer monitoring unit (TMU) 112. The TMU is mounted near the container loading area, preferably in the upper section of the loading bay 106 outside the door 110 facing the loading facility lot 108 or an interior/rear of a container 102 if one is docked at the respective loading bay. To protect the TMU from inclement weather, it could be mounted under a bay awning 114. Once docked, goods can be loaded onto/unloaded from the container 102 with the TMU 112 maintaining a view of the rear/inside of the container.

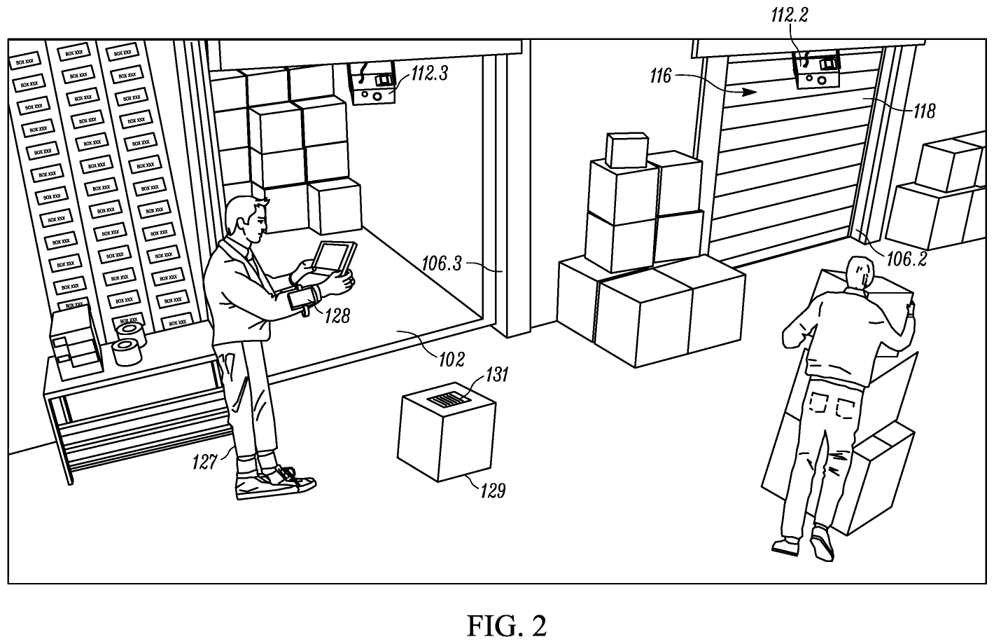

FIG. 2 is an exemplary perspective view of the loading facility 104 of FIG. 1, as seen from the inside, depicting container 102 of a trailer docked at a loading bay 106.3 with an open container door and container 116 docked at a loading bay 106.2 with a closed container 118 of another trailer. To help determine whether packages and properly delivered to the correct container, TMUs 112 (112.2 and 112.3 are shown) are employed, as described further below.

A loader 127 loads and unloads packages to and from the container 102. In the illustrated example, the loader 127 is a person, wearing a wearable computer 128 that is used by the loader 127 to scan packages (such as package 129 having an indicia 131) as they are loaded or unloaded. The wearable computer 128 may be a client device in the form of a mobile device, such as a tablet, smartphone, laptop, wrist-mounted device, or other such mobile computing device. In some embodiments, the wearable computer 128 includes a scanner for scanning an indicia on the package. The indicia may be a barcode, a universal product code, a quick read code, radio frequency identification code, or combinations thereof. Therefore, in some examples, the wearable computer 128 has a barcode scanner.

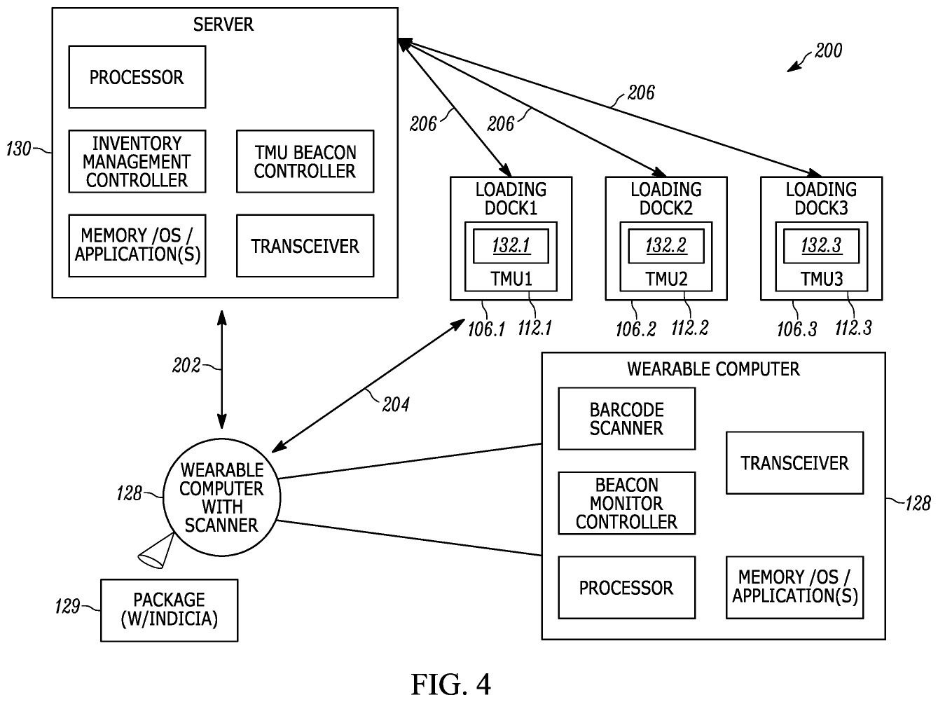

In some embodiments, the TMU 112 collects and processes 3D and/or 2D image data for use by other devices (e.g., client device 128) or server 130 (which can be in a form of a single or multiple computers operating to manage access to a centralized resource or service in a network). The processing of the image data may generate post-scanning data that may include metadata, simplified data, normalized data, result data, status data, or alert data as determined from the original scanned or sensed image data. As shown in FIG. 4, which illustrates a block connection diagram between the TMU 112, server 130, and client device 128, these devices may be connected via any suitable communication means, including wired and/or wireless connectivity components that implement one or more communication protocol standards like, for example, TCP/IP, WiFi (802.11b), Bluetooth, Ethernet, or any other suitable communication protocols or standards.

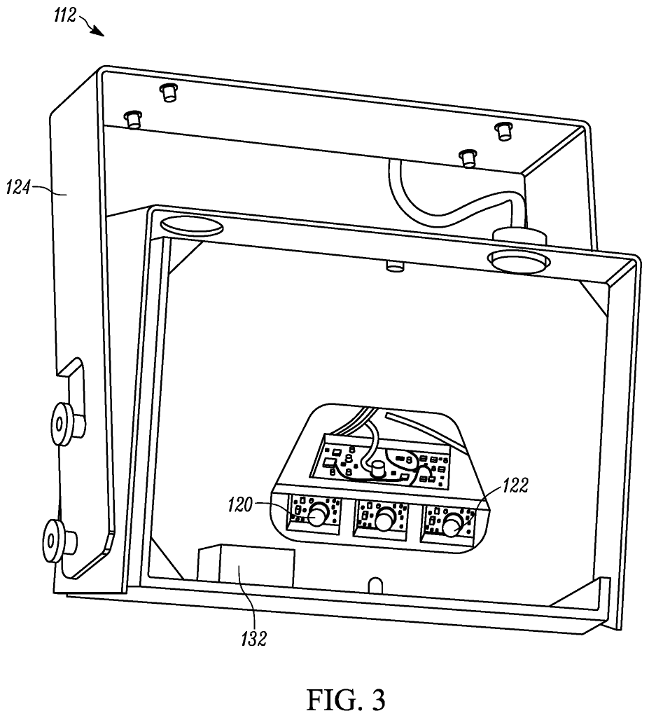

In the currently described embodiment and as shown in FIG. 3, the TMU 112 is a mountable device that includes a 3D-depth camera 120 for capturing 3D (three dimensional) images (e.g., 3D image data comprised of a plurality of points with three-dimensional point data) and a 2D camera 122 for capturing 2D images (e.g., 2D image data). The 2D camera may be an RGB (red, green, blue) camera for capturing 2D images. The TMU 112 also includes one or more processors and one or more computer memories for storing image data, and/or for executing application/instructions that perform analytics or other functions as described herein. For example, the TMU 112 may include flash memory used for determining, storing, or otherwise processing the imaging data and/or post-scanning data. In addition, TMU 112 may further include a network interface to enable communication with other devices (such as server 130). The network interface of TMU 112 may include any suitable type of communication interface(s) (e.g., wired and/or wireless interfaces) configured to operate in accordance with any suitable protocol(s). In various embodiments, and as shown in FIGS. 1 and 2, the TMU 112 is mounted via a mounting bracket 124 and oriented in the direction of docked containers to capture 3D and/or 2D image data of the interior and exterior thereof.

In an embodiment, to capture 3D image data, the 3D depth camera 120 includes an Infra-Red (IR) projector and a related IR camera, and a depth-detection application executing on one or more processors or memories of the TMU 112. Additionally, in an embodiment, to capture 2D image data, the 2D camera 122 includes an RGB (red, green, blue) based camera for capturing 2D images having RGB-based pixel data.

The TMU 112 further includes a beacon transmitter 132 to transmit a local beacon confined to the particular loading bay 106.3. Each TMU 112 in the facility 104 may have a beacon transmitter 132, and the respective beacon transmitters and TMUs are configured to confine beacons transmitted by a TMU to the respective loading bay at which that TMU is mounted. As such, a beacon for a particular TMU, such as the beacon from the TMU 112, can only be detected by a receiver at the loading bay for that TMU, e.g., at the loading bay 106.3 in the example of FIG. 2. Further still, each TMU 112 may be configured to transmit at different beacon on its respective beacon transmitter 132.

In some examples, the beacon transmitter 132 is a Bluetooth beacon, an ultrasound beacon, a WIFI beacon, or a light-based beacon. Regardless of modality, the beacon transmitter 132 transmits a beacon that can be picked up by the wearable computer 128 of the loader 127 over a communication link 204. Further, as discussed further herein, in response to receiving the beacon, the wearable computer 128 may alert the loader 127, when the detected beacon does not match that of an expected TMU beacon.

FIG. 4 illustrates an example communication network 200 for implementing the methods herein. In the illustrated example, the wearable computer 128 includes one or more processors and one or more memories, storing applications for execution by the one or more processors. The wearable computer 128 includes barcode image scanner, and a transceiver for communication over a wireless and/or wired network. The transceiver may be include a Wi-Fi transceiver for communicating with the server 130 over a first data link 202. The transceiver may further include a receiver for receiving beacon signals any of the TMUs 112 within the facility 104. In the illustrated example, three TMUs are shown labeled 112.1, 112.2, and 112.3 corresponding to loading bays 106.1, 106.2, and 106.3, respectively. As such, the transceiver at each wearable computer may further include a Bluetooth transceiver, an ultrasound receiver, and/or a light-based receiver.

Referring to FIG. 4, when implemented as a Bluetooth beacon transmitter, the transmitter 132.3 transmits a Bluetooth signal specific to TMU 112.3, and the wearable computer 128 receives that Bluetooth signal using a Bluetooth transmitter within its transceiver. To confine the Bluetooth beacon to the loading bay around the TMU 112.3, the Bluetooth transmitter may use a low Bluetooth energy (BLE) signal incapable of traveling to an adjacent loading bay.

In some examples, the beacon may be encoded with an address data field specific to the respective TMU. The wearable computer detects the beacon for the specific TMU, based on this address field. In some examples, the beacon transmitter 132.3 may be a directional transmitter, such that its beacon signal is transmitted downward only toward the opening of the respective loading bay. In other words, beacon confinement may be achieved by configuring the beacon signal and/or by configuring the beacon transmitter.

For an example ultrasound beacon, the transmitter 132.3 may include a directional speaker and associated modules to transmit in an ultrasonic range that is unique to each TMU 112. In some such examples, the wearable computer 128 includes an audio microphone configured to receive the transmitted audio beacon.

In yet other examples, the beacon transmitter 132.3 may transmit a beacon over a Wi-Fi channel, and a Wi-Fi transmitter in the wearable computer 128 detects the beacon using a Wi-Fi transceiver.

The wearable computer 128 further includes a beacon monitor controller, discussed further below.

The server 130 includes one or more processors and one or more memories, storing applications for execution by the one or more processors. The server 130 includes a transceiver, which may be Wi-Fi transceiver for communicating with the server wearable device over the data link 202 and for communicating with the TMUs 112 over a data link 206. The server 130 further includes an inventory management controller and a TMU beacon controller, as discussed further below.

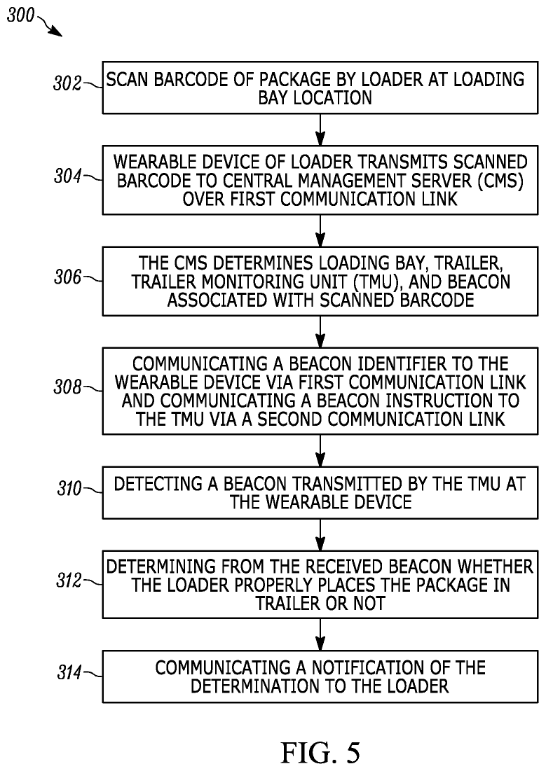

FIG. 5 illustrates a flowchart for performing a method of tracking proper placement of packages into a container and detecting misplacement of packages in the wrong container, as may be implemented by the system 200 of FIG. 4.

A process 300 starts at a block 302 when the wearable computer 128 scans a barcode of a package at a loading bay 106.3. At a block 304, the wearable computer 128 transmits, over the data link 202, scanned barcode data to the server 130, which may be implemented as a central management server (CMS). In some examples, the wearable computer 128 analyzes scanned data and decodes the barcode data, which is then sent to the server 130. In other examples, the wearable computer 128 sends the scanned data to the server 130 for analysis and decoding.

At a block 306, the server 130 analyzes the barcode (for example by analyzing the barcode data using the inventory management controller) and determines the appropriate loading bay, trailer monitoring unit, beacon, and trailer (or container) associated with the scanned barcode data. Some packages may have been delivered to the loading bay 106.3 to be placed on the container 102 for shipment to a first location, whereas other packages may be at the loading bay 106.3 by mistake and should be placed on containers at other loading bays.

The server 130, at a block 308, communicates a beacon identifier to the wearable device 128 over the data link 202 and communicates a beacon instruction to the identified TMU via data link 206. The beacon instruction may instruct the TMU 112.3 to start transmitting a beacon at the loading bay 106.3. In some examples, however, the TMUs 112 constantly transmit beacons, and a beacon instruction from the server is not used.

The wearable device detects a beacon at block 310. When in the vicinity of the loading bay 106.3, the detected beacon should be the beacon from the identified TMU 112.3. At a block 312, the wearable computer 128 compares the detected beacon to the beacon identifier received from the server 130, and the wearable computer 128 determines whether the loader 127 is at the appropriate loading bay 106.3. The wearable computer 128 further determines if the loader 127 has placed the package in the container 102 or not, at block 312. At block 314, the wearable computer 128 communicates the determination to the loader 127. In some examples, the wearable computer 128 communicates only a determination that the package was not properly loaded into the container 102, so that the loader 127 may take appropriate action.

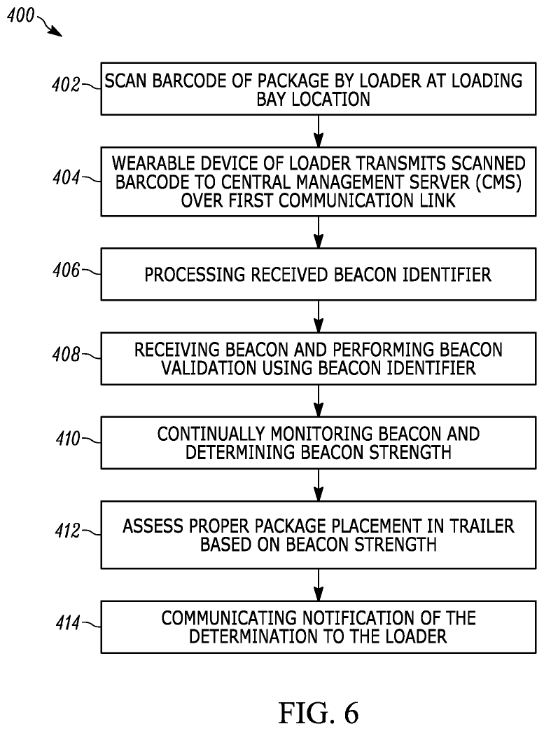

FIG. 6 illustrates a flowchart representative of a process performed by the wearable computer 128 implementing the process of FIG. 5. A process 400 starts at block 402 when the wearable computer 128 scans a barcode of a package at a loading bay 106.3. At a block 404, the wearable computer 128 transmits, over the data link 202, scanned barcode data to the server 130. The wearable computer 128 receives a beacon identifier from the server 130 and processes the beacon identifier and stores it, at block 406, such that upon receiving a beacon, the wearable computer 128 can perform a beacon validation comparison to the beacon identifier, at a block 408. When the beacon is validated, the loader 127 and wearable computer 128 are at the appropriate location for loading a package.

To determine the that package has been loaded on to the container 102, in some examples, the wearable computer 128 continually monitors the beacon and determines a signal strength for the beacon signal, at a block 410. From the assessment, at a block 412, the wearable computer 128 determines that a package has been properly placed in the container 102 by identifying an increase in signal strength to an apex, representing the closest point to the TMU of the identified loading bay (e.g., TMU 112.3 at loading bay 106.3), and then a tapering of the beacon signal, indicating the loader has moved the package into the container. Appropriate placement of the package may be communicated to the loader 127 at block 414, for example, on a display of the wearable device. Or, if the wearable computer 128 determines, from the beam signal strength, that the loader 127 has not placed the package on the container that determination is communicated to the display of the wearable device and may be communicated by an audible alarm indication.

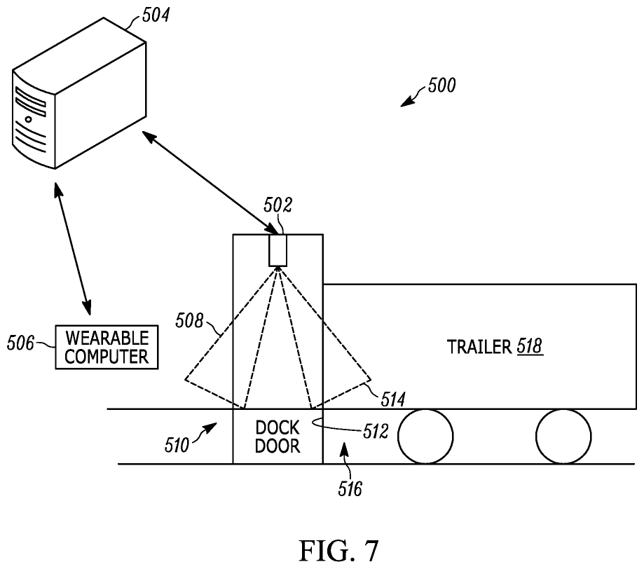

FIG. 7 illustrates another example loading bay 500, from a side view. The loading bay 500 includes a TMU 502 capable of communicating with a server 504, in accordance with example processes described herein. A wearable computer 506 is also shown and communicates with the server 504, in accordance with example processes described herein. The wearable computer 506 is able to receive and analyze beacons transmitted from the TMU 502, in accordance with examples described herein. In the illustrated example, the TMU 502 differs from the TMU 112 in that the former has two beacon transmitters, one beacon is a loading bay beacon 508 emitted by the TMU 502 and confined to a first region 510 proximate to a loading bay opening 512 (or loading dock door). The TMU 502 also transmits a trailer beacon 514 confined to a second region 516 proximate to a trailer 518 at the loading bay 500. In exemplary embodiments, the regions 510 and 516 are non-overlapping.

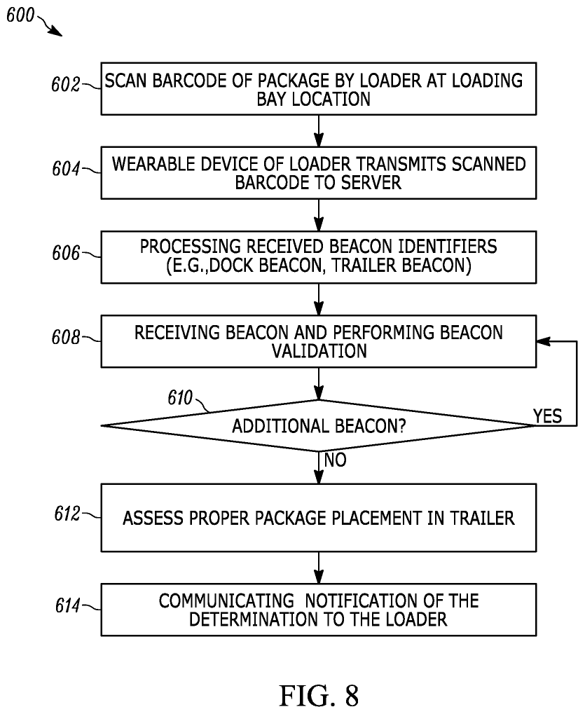

FIG. 8 illustrates a flowchart of a process that may be performed by the system of FIG. 7 using multiple beacons to determine proper placement of a package in a the trailer 518. A process 600 starts a block 602 when the wearable computer 506 scans a barcode of a package at a loading bay 500. The wearable computer 506 transmits the scanned barcode to the server 504, for example, over a wireless communication link. The server 504 analyzes the barcode determines the appropriate loading bay 500, TMU 502, and identifying that the TMU 502 has multiple beacons, determines a beacon identifier for the loading bay beacon and another beacon identifier for the trailer beacon. The server 504 communicates the two beacon identifiers to the wearable computer 506, which processes the beacon identifiers and stores them, at 606. The wearable computer 506 receives beacon signals at the loading bay 500 and performs a validation to determine if the received beacon signals correspond to either a loading bay beacon or a trailer beacon or another beacon. The process at blocks 608 and 610 cycles until the received beacon is compared against each of the multiple beacons that may be emitted by the TMU 502.

In some embodiments, the server can be implemented partially or fully within either any of the wearable computers or within any of the TMUs.

At a block 612, the wearable computer 506 examines the identified beacons from the processes 608 and 610 to determine if the package has been moved into the trailer. In some examples, the wearable computer 506 determines if it first receives a loading bay beacon emitted by the TMU 502, indicating that the loader (not shown) has the package at the first region 510 for placing the package on the trailer 518. If the wearable computer 506 validates detection of the loading bay beacon, at a block 612, the wearable computer 506 may determine if the next received beacon is a trailer beacon, thereby indicating that the loader has moved the package to region 516 and onto the trailer 518. By using this multiple step process, and in beacon sequencing order, the wearable computer is able to more completely assess placement of the package into a trailer or container as compared to the signal strength determination of FIG. 6. At a bock 614, the determination of whether the loader has satisfied both beacon conditions or not is communicated to the loader via the wearable computer 506.

The terms transmitter, receiver, and transceiver are used herein for example purposes and should not be construed as limiting. For example, it will be understand that references to an element being a transmitter or a receiver include that element being a transceiver. Furthermore, any reference to an element being a transceiver may include that element being implemented as a transmitter and/or receiver depending on whether the element is sending and/or receiving data.

While the techniques herein have been described in terms of examination proper placement of a package at a loading facility onto a container (or trailer) at a loading bay, the techniques could be modified to assess whether a package on a container (or trailer) when scanned by a wearable computer is determined be at the proper loading bay. The operation processes would be similar to the techniques described above, with the wearable computer communicating with a server, after scanning an indicia and then, after receiving beacon identification information from the server, determining, as the package is removed from the container (or trailer) whether the package is being removed at the appropriate loading bay or not.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of tracking proper placement of a package into a trailer at a loading dock having a plurality loading bays facing a loading dock facility, each bay having a respective trailer monitoring unit, the method comprising:
scanning, via a wearable scanner associated with a loader at the load docking, an indicia identifying the package;
the wearable scanner transmitting the scanned indicia to a server via a network communication link;
the server determining, from the indicia, an assigned loading bay for the package from among the plurality of loading bays and determining an assigned trailer monitoring unit corresponding to the assigned loading bay, the server further determining a beacon identifier identifying a loading bay beacon of the assigned trailer monitoring unit,
the server communicating the beacon identifier to the wearable scanner via the network communication link;
detecting, at the wearable scanner, a beacon and determining, at the wearable scanner, if the detected beacon is the loading bay beacon emitted by the assigned trailer monitoring unit;
if the detected beacon is the loading bay beacon, then in response to the loader moving the package relative to the assigned loading bay and/or relative to the trailer, determining, at the wearable scanner, when the package satisfies at least one of (1) a first condition indicating proper placement of the package in the trailer and (2) a second condition indicating improper placement of the package.

2. The method of claim 1, further comprising determining when the package satisfies the first condition and when the package satisfies the second condition by detecting, at the wearable scanner, a beacon signal strength of the loading bay beacon and analyzing increases and/or decreases in the beacon signal strength.

3. The method of claim 1, further comprising:
the server determining, from the indicia, a secondary beacon identifier identifying a trailer beacon of the assigned trailer monitoring unit; and
the server communicating the secondary beacon identifier to the wearable scanner via the network communication link.

4. The method of claim 3, further comprising determining when the package satisfies the first condition and when the package satisfies the second condition by:
receiving, at the wearable scanner, the loading bay beacon emitted by the assigned trailer monitoring unit;
verifying, at the wearable scanner, the loading bay beacon as corresponding to the beacon identifier;
receiving, at the wearable scanner, the trailer beacon emitted by the assigned trailer monitoring unit; and
verifying, at the wearable scanner, the trailer beacon as corresponding to the secondary beacon identifier.

5. The method of claim 3, further comprising determining when the package satisfies the first condition by detecting the loading bay beacon and detecting the trailer beacon in sequence.

6. The method of claim 3, wherein the loading bay beacon is confined to a first region proximate to the assigned loading bay and wherein the trailer beacon is confined to a second region proximate to the trailer at the assigned loading bay, wherein the first region and the second region are non-overlapping.

7. The method of claim 1, wherein the loading bay beacon is a Bluetooth beacon, an ultrasound beacon, a WIFI beacon, or a light-based beacon.

8. The method of claim 1, wherein the indicia is a barcode, a universal product code, a quick read code, radio frequency identification code, or combinations thereof.

9. The method of claim 1, wherein the server is hosted on one of the trailer monitoring units.

10. A method of tracking proper placement of a package into a trailer at a loading dock having a plurality loading bays facing a loading dock facility, each bay having a respective trailer monitoring unit, the method comprising:
scanning, via a wearable scanner associated with a loader at the load docking, an indicia identifying the package;
the wearable scanner transmitting the scanned indicia to a server via a network communication link;
the server determining, from the indicia, an assigned loading bay for the package from among the plurality of loading bays and determining an assigned trailer monitoring unit corresponding to the assigned loading bay;
the server determining, from the indicia, a loading bay beacon, a loading bay beacon identifier, and a loading bay beacon instruction,
the server communicating the loading bay beacon instruction to the assigned trailer monitoring unit and the server communicating the loading bay beacon identifier to the wearable scanner via the network communication link;
the assigned trailer monitoring unit emitting the loading bay beacon in accordance with the loading bay beacon instruction,
detecting, at the wearable scanner, the loading bay beacon and, in response to the loader moving the package relative to the assigned loading bay and/or relative to the trailer, determining, at the wearable scanner, when the package satisfies at least one of (1) a first condition indicating proper placement of the package in the trailer and (2) a second condition indicating improper placement of the package.

11. The method of claim 10, wherein the loading bay beacon is an indicia-specific beacon, a trailing monitoring unit-specific beacon, or a combination thereof.

12. The method of claim 10, further comprising determining when the package satisfies the first condition and when the package satisfies the second condition by detecting, at the wearable scanner, a beacon signal strength of the loading bay beacon and analyzing increases and/or decreases in the beacon signal strength.

13. The method of claim 10, further comprising:
the server determining, from the indicia, a trailer beacon, a trailer beacon identifier, and a trailer beacon instruction; and
the server communicating the trailer beacon instruction to the assigned trailer monitoring unit and the server communicating the trailer beacon identifier to the wearable scanner via the network communication link.

14. The method of claim 13, further comprising determining when the package satisfies the first condition and when the package satisfies the second condition by:
receiving, at the wearable scanner, the loading bay beacon emitted by the assigned trailer monitoring unit;
verifying, at the wearable scanner, the loading bay beacon as corresponding to the loading bay beacon identifier;
receiving, at the wearable scanner, the trailer beacon emitted by the assigned trailer monitoring unit; and
verifying, at the wearable scanner, the trailer beacon as corresponding to the trailer beacon identifier.

15. The method of claim 13, further comprising determining when the package satisfies the first condition by detecting the loading bay beacon and detecting the trailer beacon in sequence.

16. The method of claim 13, wherein the loading bay beacon is confined to a first region proximate to the assigned loading bay and wherein the trailer beacon is confined to a second region proximate to the trailer at the assigned loading bay, wherein the first region and the second region are non-overlapping.

17. The method of claim 10, wherein the loading bay beacon is a Bluetooth beacon, an ultrasound beacon, a WIFI beacon, or a light-based beacon.

18. The method of claim 10, wherein the indicia is a barcode, a universal product code, a quick read code, radio frequency identification code, or combinations thereof.

19. A method of tracking proper placement of a package into a trailer at a loading dock having a plurality loading bays facing a loading dock facility, each bay having a respective trailer monitoring unit, the method comprising:
scanning the package for package data and identifying the package from the scanned package data;
determining an assigned loading bay for the package based on the scanned package data;
identifying to a mobile computer of a package loader, an assigned beacon of the assigned loading bay;
receiving, at the mobile computer, a beacon and authenticating the received beacon as the assigned beacon; and
if the received beacon is the assigned beacon, then monitoring a location of the package at the loading dock and determining when the package has satisfied at least one of a proper placement condition into a trailer at the loading dock location and determining when the package has satisfied an improper placement condition; and
in response to determining improper placement, communicating the determination of the improper placement to the mobile computer.

20. A method of claim 19, further comprising, in response to determining proper placement, communicating the determination of the proper placement to the mobile computer.

21. A method of tracking proper placement of a package into a trailer at a loading dock having a plurality loading bays facing a loading dock facility, each bay having a respective trailer monitoring unit, the method comprising:
scanning, via a wearable scanner associated with a loader at the load docking, an indicia identifying the package;
the wearable scanner communicating the scanned indicia to a server hosted on the wearable scanner;
the server determining, from the indicia, an assigned loading bay for the package from among the plurality of loading bays and determining an assigned trailer monitoring unit corresponding to the assigned loading bay, the server further determining a beacon identifier identifying a loading bay beacon of the assigned trailer monitoring unit,
the server communicating the beacon identifier to the wearable scanner;
detecting, at the wearable scanner, a beacon and determining, at the wearable scanner, if the detected beacon is the loading bay beacon emitted by the assigned trailer monitoring unit;
if the detected beacon is the loading bay beacon, then in response to the loader moving the package relative to the assigned loading bay and/or relative to the trailer, determining, at the wearable scanner, when the package satisfies at least one of (1) a first condition indicating proper placement of the package in the trailer and (2) a second condition indicating improper placement of the package.
